(19) United States
(12) Patent Application Publication
(10) Pub. No.: US 2019/0351422 A1
(43) Pub. Date: Nov. 21, 2019

(54) HEAT EXCHANGE ASSEMBLY FOR FLOW CIRCUITS

(71) Applicant: HeartWare, Inc., Miami Lakes, FL (US)

(72) Inventors: Zoe N. DEMOU, Miami, FL (US); Joshua PEREZ, Hialeah, FL (US)

(21) Appl. No.: 16/407,665

(22) Filed: May 9, 2019

Related U.S. Application Data
(60) Provisional application No. 62/672,774, filed on May 17, 2018.

(51) Int. Cl. B01L 7/00; B01L 3/00

(52) U.S. Cl. CPC B01L 7/00; B01L 3/561; B01L 3/502; B01L 2300/0663; B01L 2300/185; B01L 2200/147; B01L 3/505

(57) ABSTRACT

A flow circuit, such as a blood loop or in vitro closed-loop pump-driven circulation system for blood or other fluid including a heat exchange assembly that maintains a temperature of a sample fluid at body temperature. In one embodiment, the flow circuit is vertically oriented. In one embodiment, the flow circuit is an in vitro closed-loop blood circulation system comprises: a first closed-loop fluid flow path containing a warming fluid circulated therein and including a vertically oriented housing assembly; and a second closed-loop fluid flow path containing a sample fluid circulated therein, the first closed-loop fluid flow path and the second closed-loop fluid flow path being in a thermal exchange relationship with each other, at least a portion of the second closed-loop fluid flow path being vertically suspended from the vertically oriented housing assembly.

### CROSS-REFERENCE TO RELATED APPLICATION

This application claims the benefit of U.S. Application Ser. No. 62/672,774, filed May 17, 2018.

### FIELD

The present technology is generally related to a method and system for temperature maintenance in a flow circuit (in vitro closed-loop pump-driven circulation systems or blood loops or other fluid loops), such as a heat exchange assembly for use in a blood loop.

### BACKGROUND

Medical devices that contact circulating blood during use may produce undesirable interactions with the blood, which can induce blood trauma and/or impair the functionality of, or even destroy, the components of blood. Such interactions may include hemolysis (the lysis, or destruction, of red blood cells) thrombosis (blood clotting), and inflammation. A flow circuit such as an in vitro closed-loop blood circulation system, also referred to as a “blood loop,” may be used to test the hemocompatibility of a device and/or its coating before the device is used in a human patient.

An exemplary blood loop currently known in the art includes a blood sample within a section of tubing. The blood is circulated throughout the tubing by a pump (for example, a roller pump), and the tubing is contained within an incubator, heating cabinet, or warm water bath that keeps the blood sample at body temperature (37° C./98.6° F.). Alternatively, some currently known systems are used in a room that is heated to 37° C./98.6° F. to maintain the blood sample at the proper temperature. The tubing of the exemplary blood loop also includes one or more sampling ports and the system may include one or more flow sensors.

Such a currently known blood loop creates several disadvantages. Maintaining the blood sample in a heated room can make for an uncomfortable environment for the laboratory technicians. If the blood loop instead includes a water bath for keeping the blood sample at body temperature, the sampling ports are submerged within the water. Withdrawing blood though a wet sampling port increases the likelihood of cross contamination. Further, the tubing is horizontally oriented when the currently known blood loop is in use (for example, the tubing is placed on a lab bench or work surface). However, the horizontal orientation of the tubing causes microbubbles within the blood sample to accumulate and interfere with the flow sensors and sample collection, and create “dead spots” within the blood loop. Additionally, a horizontal orientation means the blood loop occupies a large area of space on the work surface, that is, has a large footprint.

### SUMMARY

Some embodiments advantageously provide a vertically oriented flow circuit including a heat exchange assembly that maintains a temperature of a sample fluid at body temperature or other target temperature.

In one embodiment, a heat exchange assembly for a flow circuit comprises: a housing assembly including: a fluid reservoir including a first end and a second end opposite the first end; at least one tube in fluid communication with the fluid reservoir, the fluid reservoir and the at least one tube being a closed-loop fluid flow path; a first end plate coupled to the first end of the fluid reservoir; and a second end plate coupled to the second end of the fluid reservoir.

In one aspect of the embodiment, the heat exchange assembly further comprises a pump, the pump being in at least one of mechanical and fluid communication with the at least one tube. In one aspect of the embodiment, the pump is a roller pump.

In one aspect of the embodiment, the heat exchange assembly further comprises a temperature modification element, the heating element being in a thermal exchange relationship with the at least one tube. In one aspect of the embodiment, the temperature modification element is a heating element.

In one aspect of the embodiment, the second end plate is vertically aligned with the first end plate.

In one aspect of the embodiment, the second end plate is horizontally aligned with the first end plate.

In one aspect of the embodiment, the closed-loop fluid flow path contains a heat exchange fluid.

In one aspect of the embodiment, the temperature modification element is configured to maintain a temperature of the heat exchange fluid at a target temperature. In one aspect of the embodiment, the target temperature is 37° C./98.6° F.

In one aspect of the embodiment, the housing assembly further includes a plurality of upright supports, each of the first end plate and the second end plate having a plurality of upright support apertures, the first end plate and the second end plate being coupled to the fluid reservoir by the plurality of upright supports. In one aspect of the embodiment, each of the plurality of upright supports extends between a one of the plurality of upright support apertures in the second end plate and a corresponding one of the plurality of upright support apertures in the first end plate.

In one aspect of the embodiment, the second end plate includes a first surface, a second surface, a recessed area in the first surface, and a gasket membrane aperture extending between the first surface and the second surface. In one aspect of the embodiment, the heat exchange assembly further comprises a gasket membrane seated within the recessed area in the second end plate, the gasket membrane including a first aperture and a second aperture.

In one embodiment, a flow circuit comprises: first closed-loop fluid flow path, the first closed-loop fluid flow path including: a housing assembly having: a fluid reservoir with a first end and a second end opposite the first end, the fluid reservoir containing a heat exchange fluid; a top end plate coupled to the first end of the fluid reservoir; a bottom end plate coupled to the second end of the fluid reservoir, the bottom end plate having an aperture; and a gasket membrane extending across the aperture in the bottom end plate. In this embodiment, the first closed-loop fluid flow path further includes: at least one heat exchange fluid tube in fluid communication with the fluid reservoir; a first pump in at least one of fluid communication and mechanical communication with the at least one heat exchange fluid tube, the first pump being operable to circulate the heat exchange fluid within the first closed-loop fluid flow path; and a temperature modification element, the temperature modification element being in a thermal exchange relationship with the at least one heat exchange fluid tube. In this embodiment, the flow circuit further comprises: a second closed-loop fluid flow path, the second closed-loop fluid flow path including: a sample bag located within the fluid reservoir, the sample bag containing a sample fluid; at least one sample tube in fluid communication with the sample bag, at least a portion of the at least one sample tube extending through the gasket membrane such that the at least one sample tube is suspended from the housing assembly; and a second pump in mechanical communication with the at least one sample tube, the second pump being operable to circulate the sample fluid throughout the second closed-loop fluid flow path.

In one aspect of the embodiment, a temperature of the sample fluid is maintained at body temperature by a temperature of the heat exchange fluid.

In one aspect of the embodiment, the first closed-loop fluid flow path is in a thermal exchange relationship with the second closed-loop fluid flow path.

In one aspect of the embodiment, the top end plate and the bottom end plate are vertically aligned, the at least one sample tube being vertically suspended from the bottom end plate.

In one aspect of the embodiment, the at least one sample tube includes a sampling port, the sampling port being located external to the fluid reservoir.

In one embodiment, an in vitro closed-loop blood circulation system comprises: a first closed-loop fluid flow path containing a warming fluid circulated therein and including a vertically oriented housing assembly; and a second closed-loop fluid flow path containing a sample fluid circulated therein, the first closed-loop fluid flow path and the second closed-loop fluid flow path being in a thermal exchange relationship with each other, at least a portion of the second closed-loop fluid flow path being vertically suspended from the vertically oriented housing assembly.

In one aspect of the embodiment, the second closed-loop fluid flow path includes at least one sensor, the system further comprising a control unit in communication with the at least one sensor. In one aspect of the embodiment, the control unit is configured to automatically adjust the system such that a temperature of the sample fluid is maintained at body temperature.

In one aspect of the embodiment, the first closed-loop fluid flow path further includes a temperature modification element, the temperature modification element being configured to maintain a temperature of the warming fluid at body temperature.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a simplified view of an exemplary vertically oriented in vitro closed-loop pump-driven circulation system or flow circuit (such as a blood loop);

FIG. 2 shows the flow circuit of FIG. 1 in greater detail;

FIG. 3 shows a top perspective view of a water bath tank of a heat exchange assembly of the flow circuit;

FIG. 4 shows a top perspective view of view of a housing assembly of the heat exchange assembly;

FIG. 5 shows a side view of the housing assembly;

FIG. 6 shows a top surface of a first or top end plate of the housing assembly;

FIG. 7 shows a bottom surface of the top end plate of the housing assembly;

FIG. 8 shows a cross-sectional view of the top end plate of the housing assembly;

FIG. 9 shows a top surface of a second or bottom end plate of the housing assembly;

FIG. 10 shows a bottom surface of the bottom end plate of the housing assembly;

FIG. 11 shows a cross-sectional view of the bottom end plate of the housing assembly;

FIG. 12 shows a gasket membrane for use within the housing assembly;

FIG. 13 shows a simplified view of the in vitro closed-loop pump-driven circulation system or flow circuit (such as a blood loop) of FIG. 1 in a partially horizontal orientation with a vertically oriented housing assembly;

FIG. 14 shows a simplified view of an exemplary in vitro closed-loop pump-driven circulation system or flow circuit (such as a blood loop) in a partially horizontal orientation with a horizontally oriented housing assembly;

FIG. 15 shows a simplified view of an exemplary in vitro closed-loop pump-driven circulation system or flow circuit (such as a blood loop) in a first embodiment of a completely horizontal orientation with a horizontally oriented housing assembly; and

FIG. 16 shows a simplified view of an exemplary in vitro closed-loop pump-driven circulation system (such as a blood loop) in a second embodiment of a completely horizontal orientation with a horizontally oriented housing assembly.

### DETAILED DESCRIPTION

Before describing in detail exemplary embodiments, it is noted that the embodiments reside primarily in combinations of apparatus components and processing steps related to a flow circuit such as an in vitro closed-loop pump-driven circulation system, such as a blood loop. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. In some embodiments, however, the terms “top,” “bottom,” “vertical” and “horizontal” are used in their commonly understood meaning. For example, the term “vertical” is used herein to mean at a right angle to a horizontal plane (such as a floor or workbench surface); or having an alignment, such that the top is directly above the bottom. As a further example, the term “horizontal” is used herein to mean at a right angle to the vertical; parallel to the plane of the horizon. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

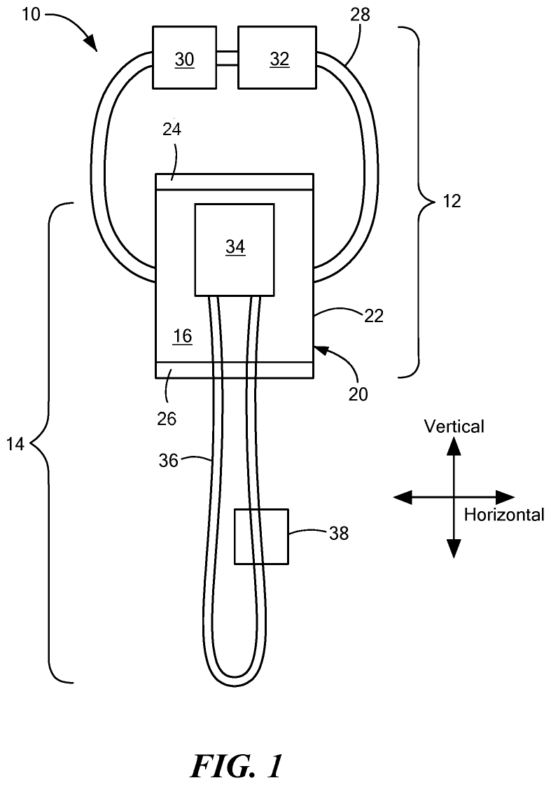

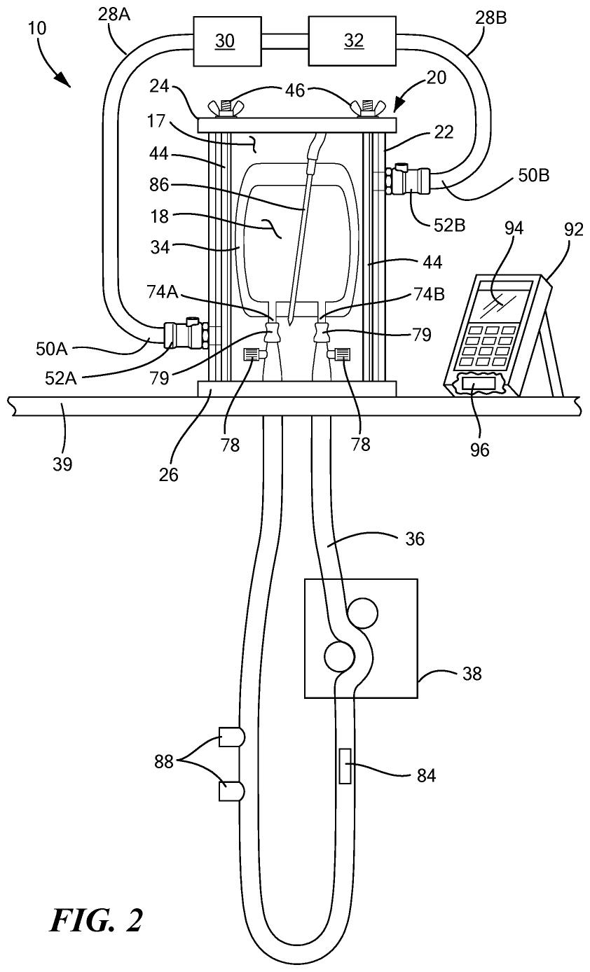

Referring now to FIGS. 1 and 2, an in vitro closed-loop blood circulation system, or blood loop (flow circuit) 10, is shown. Although the terms “blood circulation system” and “blood loop” are used herein, it will be understood that the system shown and described may be used for fluids other than blood, as the blood loop 10 may be used for any of a variety of in vitro experimental systems that require temperature maintenance in a flow system, either by removing or adding heat. The blood loop 10 generally includes a first closed-loop fluid flow path 12 and a second closed-loop fluid flow path 14. The first closed-loop fluid flow path 12 generally includes a heat exchange assembly 16 and heat exchange fluid 17 and the second closed-loop fluid flow path 14 generally includes a sample fluid 18, such as a blood sample. The second closed-loop fluid flow path 14 is adjusted or maintained at a desired or target temperature by the first closed-loop fluid flow path 12. In one embodiment, the heat exchange assembly 16 generally includes a housing assembly 20 with a water bath tank 22, a first or top end plate 24, and a second or bottom end plate 26. The heat exchange assembly 16 also includes at least one water bath tube 28 (which may also be referred to herein as at least one heat exchange fluid tube 28), a pump 30, and a temperature modification element 32 that is configured to warm, cool, and/or maintain the heat exchange fluid 17 at a target temperature. In one non-limiting example, the temperature modification element 32 includes at least one heating element that is configured to warm and/or maintain the heat exchange fluid 17 to a temperature sufficient to bring and/or maintain the sample fluid 18 to or at body temperature (37° C./98.6° F.). However, in other embodiments, the temperature modification element 32 includes at least one cooling element may be used in addition to or instead of at least one heating element to reduce and/or maintain a temperature of the heat exchange fluid 17 to a temperature sufficient to bring and/or maintain the sample fluid 18 to or at a target temperature.

In one embodiment, the second closed-loop fluid flow path 14 generally includes a blood sample bag 34, at least one sample tube 36 in fluid communication with the blood sample bag 34, and a pump 38 for maintaining circulation of the blood throughout the sample tube(s) 36 and blood sample bag 34. Although a single water bath tube 28 and a single sample tube 36 may be referred to herein, it will be understood that any number of tubes and/or length of tubing may be used to enable fluid communication between the appropriate components of the blood loop 10 discussed herein.

When the blood loop 10 is in use, the heat exchange assembly 16 may be positioned on a shelving unit, work top, or other surface that is a distance above the ground and the blood sample bag 34 is placed within the water bath tank 22. The sample tube(s) 36 extend from the base of, and hang vertically from, the housing assembly 20 of the heat exchange assembly 16. Put another way, the sample tube(s) 36 are suspended from the housing assembly 20 when the blood loop 10 is in use. For example, the distance by which the housing assembly 20 is located above the ground may be at least the vertical length of the sample tube(s) 36 when the sample tube(s) 36 are hanging from the housing assembly 20 and in fluid communication with the blood sample bag 34. Thus, the blood loop 10, or at least the second closed-loop fluid flow path 14, has a vertical, rather than horizontal, orientation when the blood loop 10 is in use. Although some components of the first closed-loop fluid flow path 12 are shown in FIGS. 1 and 2 for ease of visualization as being located above the housing assembly 20, it will be understood that these components may additionally or alternatively be located at other positions, such as on the same horizontal plane as, behind, or beneath the housing assembly 20, without departing from the vertical orientation of the housing assembly 20, the second closed-loop fluid flow path 14, or the blood loop 10 as a whole.

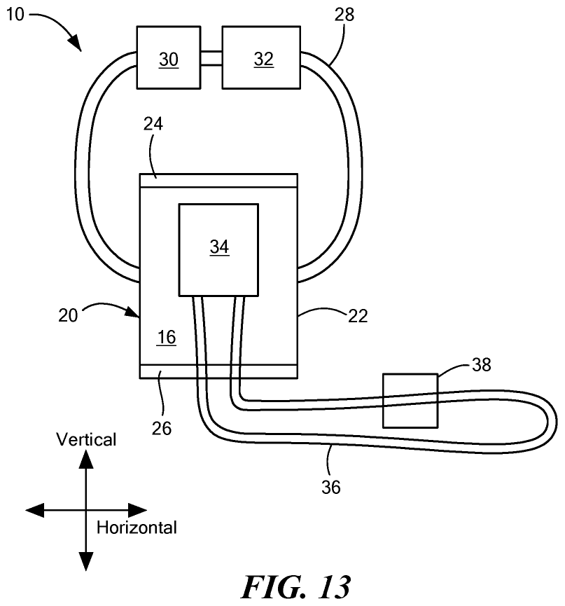

As noted above, in one embodiment, the housing assembly 20 is vertically oriented with the top end plate 24 and the bottom end plate 26 being vertically aligned with each other (that is, coaxial along a vertical axis extending orthogonally to a horizontal surface 39 on which the housing assembly 20 rests) and the sample tube(s) 36 being suspended from the housing assembly 20, and with the housing assembly 20 resting on a workbench or other horizontal surface 39. However, it will be understood that the housing assembly 20, and/or the blood loop 10 as a whole, may be partially or completely horizontally oriented. For example, the housing assembly 20 may be vertically oriented as shown in FIG. 2, but the sample tube(s) 36 may extend horizontally from, instead of being vertically suspended from, the second end plate 26 (for example, the sample tube(s) 36 may rest on or extend along the same horizontal surface 39 as the housing assembly 20, or may rest on or extend along a different horizontal surface). Such a configuration may be referred to as a partially horizontal orientation, a non-limiting example of which is shown in FIG. 13.

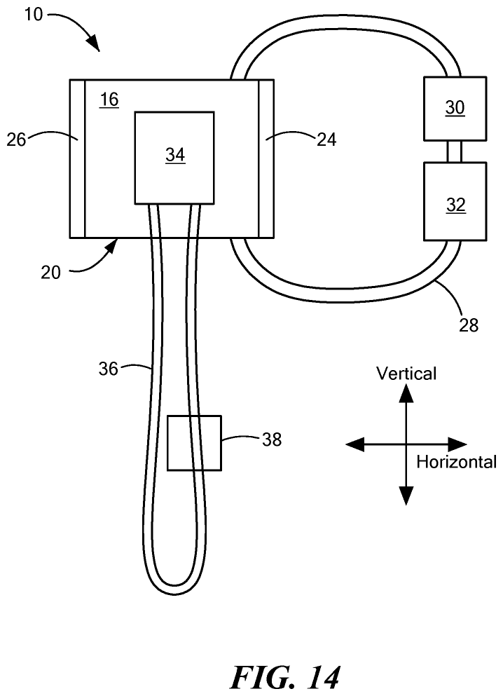

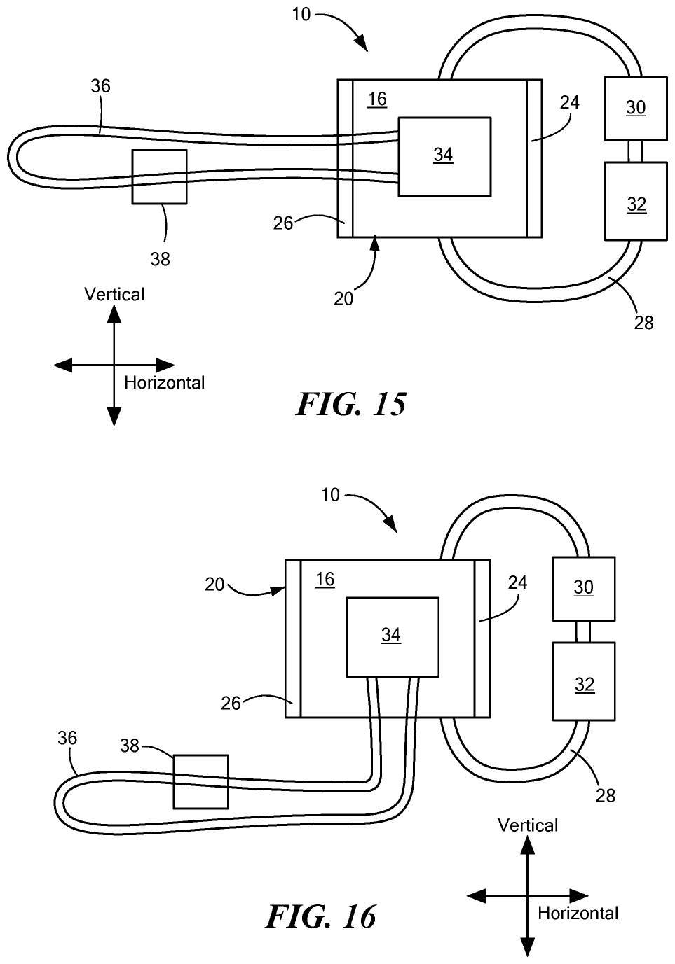

In a further example, the water bath tank 22, first end plate 24, second end plate 26, and other components of the housing assembly 20 may be assembled in a horizontal orientation (that is, rotated by approximately 90° from the orientation shown in, for example, FIG. 2, with the first and second end plates 24, 26 being coaxial along a horizontal axis extending parallel to a horizontal surface 39 on which the housing assembly 20 rests) and the sample tube(s) 36 may be suspended from a lateral wall of the water bath tank 22. In such a configuration, the first end plate 24 and second end plate 26 may be solid (that is, for example, without apertures other than the upright support apertures 56) and the wall of the water bath tank 22 may instead include water bath tank apertures 48A, 48B and additional apertures and/or gasket(s) through which the sample tube(s) 36 may extend and/or other components of the blood loop 10 may be attached. Further, in such a configuration, the sample tube(s) 36 may be suspended from the wall of the water bath tank 22 (as they are suspended from the second end plate 26 in FIG. 2). Such a configuration may also be referred to as a partially horizontal configuration, a non-limiting example of which is shown in FIG. 14. Alternatively, the sample tube(s) 36 may extend horizontally from the housing assembly 20 (for example, the sample tube(s) 36 may rest on or extend along the same horizontal surface 39 as the housing assembly 20, or may rest on or extend along a different horizontal surface). In one example (as shown in FIG. 15), the first end plate 24 and/or the second end plate 26 may include the gasket membrane aperture 62 and gasket membrane 64 (or other apertures) through which the sample tube(s) 36 extend to extend along the horizontal surface 39. In another example (as shown in FIG. 16), the housing assembly is horizontally oriented as shown in FIG. 14, and the sample tube(s) 36 extend from the wall of the water bath tank 22 along the horizontal surface 39. The configurations of FIGS. 15 and 16 may be referred to as a completely horizontal orientation. Although not shown, it will be understood that the configuration of FIG. 15 may be altered to be in a partially horizontal configuration in which the housing assembly 20 is horizontally oriented, as shown, but the sample tube(s) 36 hang or are suspended vertically from the second end plate 26 (for example, if the entire blood loop 10 shown in FIG. 13 were rotated clockwise by 90°).

In one embodiment, the heat exchange assembly 16 includes a housing assembly 20, a first water bath tube 28A, a second water bath tube 28B, a pump 30, and a temperature modification element 32 that is configured to modify and/or maintain the heat exchange fluid 17 at a target temperature, such as body temperature (37° C./98.6° F.). For example, the temperature modification element 32 may be heating element, a heat exchanger, a cooling element, or any other component capable of affecting the temperature of the heat exchange fluid 17 and, therefore, the sample fluid 18. It will be understood that the temperature modification element 32 may be configured to modify and/or maintain the heat exchange fluid 17 at any target temperature. Further, if it is desired that the sample fluid 18 be cooled, some embodiments of the blood loop 10 include a cooling element instead of or in addition to heating element(s) to modify and/or maintain the heat exchange fluid 17, and therefore the sample fluid 18, at the desired temperature.

In one embodiment, the temperature modification element 32 is an inline heater connected to the water bath tube(s) 28 or a submersible heater located within the water bath tank 22. Additionally or alternatively, the temperature modification element 32 is a heat exchanger that includes a secondary warming fluid within a secondary fluid flow path that transfers heat to the heat exchange fluid within the water bath tube(s) 28. However, it will be understood that the temperature modification element 32 may be any device suitable for increasing, adjusting, and/or maintaining the heat exchange fluid at a target temperature.

The housing assembly 20 is configured to hold a volume of fluid (referred to herein as heat exchange fluid), such as water or saline, in which a blood sample bag 34 is submerged. Although this volume of fluid is referred to as a water bath herein, it will be understood that any suitable fluid may be used. In one embodiment, the housing assembly includes a fluid reservoir, such as a water bath tank 22. In one non-limiting example, the water bath tank 22 is cylindrically shaped and is composed of acrylic, and has a height H22 of approximately 12.00 inches (±2.00 inches), an outer diameter of approximately 8.00 inches, and an inner diameter of approximately 7.50 inches. However, it is understood that the water bath tank 22 may have any suitable size, shape, and configuration. Likewise, the water bath tank 22 may be composed of any suitable material, such as glass, metal, or plastic. The water bath tank 22 includes an open first end 40 and an open second end 42 opposite the first end 40.

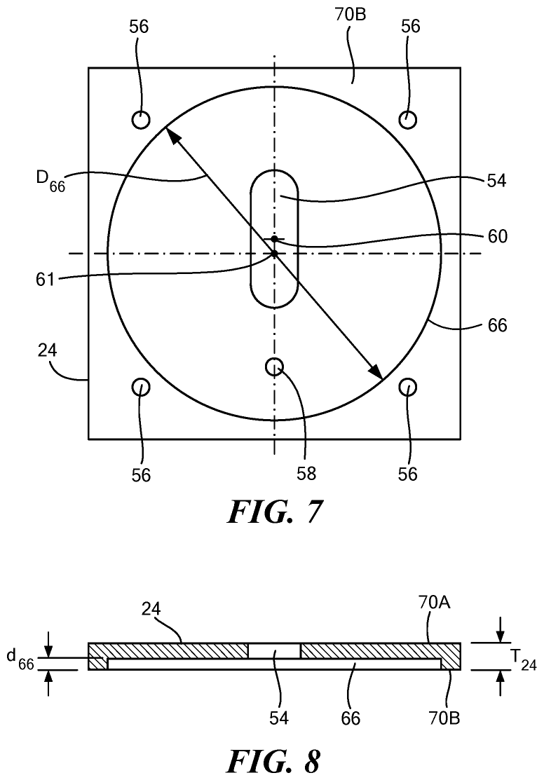

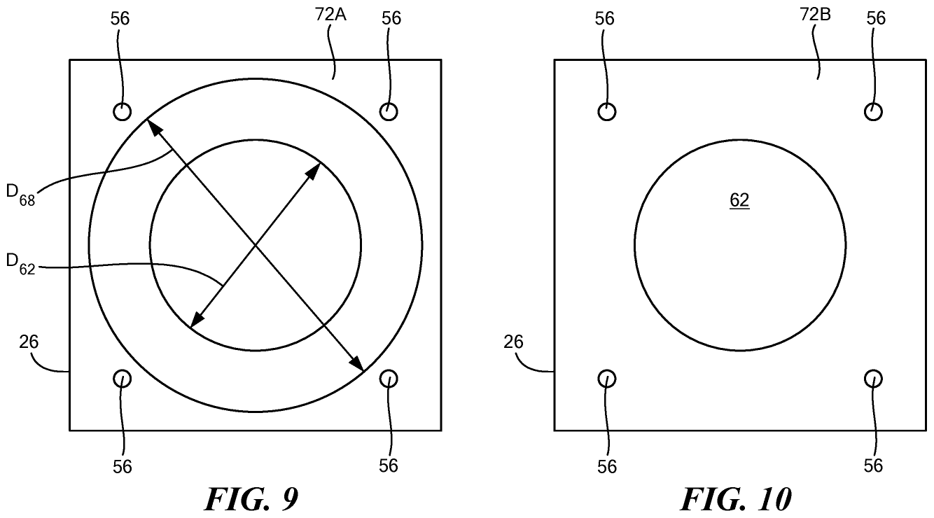

The housing assembly 20 includes a first or top end plate 24 that is in contact with the open first end 40 of the water bath tank 22 and a second or bottom end plate 26 that is in contact with the open second end 42 of the water bath tank 22. The top and bottom end plates 24, 26 are secured to the water bath tank 22 by a plurality of upright supports 44 and tightening means 46. In one embodiment, the housing assembly 20 includes four upright supports 44 extending between corresponding corners of the top and bottom end plates 24, 26 (as shown in FIG. 2). A tightening means 46 may be coupled to each upright support 44 above the top end plate 24. In one embodiment, the tightening means 46 are wingnuts that are threadably coupled or couplable to the upright supports 44, each of the wingnuts and at least a portion of each of the upright supports 44 having corresponding matable threading. Rotating the tightening means 46 in a clockwise direction around the upright supports 44 will tighten the tightening means 46 to the top end plate 24 and will draw the top and bottom end plates 24, 26 toward each other, which, in turn, secures the top and bottom end plates 24, 26 to the first and second ends 40, 42 of the water bath tank 22, respectively. As is discussed in more detail below, one surface (the water-bath-tank-contacting surface of each of the top and bottom end plates may include a recessed portion corresponding to the diameter of the water bath tank 22 to facilitate seating of the top and bottom end plates 24, 26 on the water bath tank 22 (for example, as shown in FIGS. 6-11).

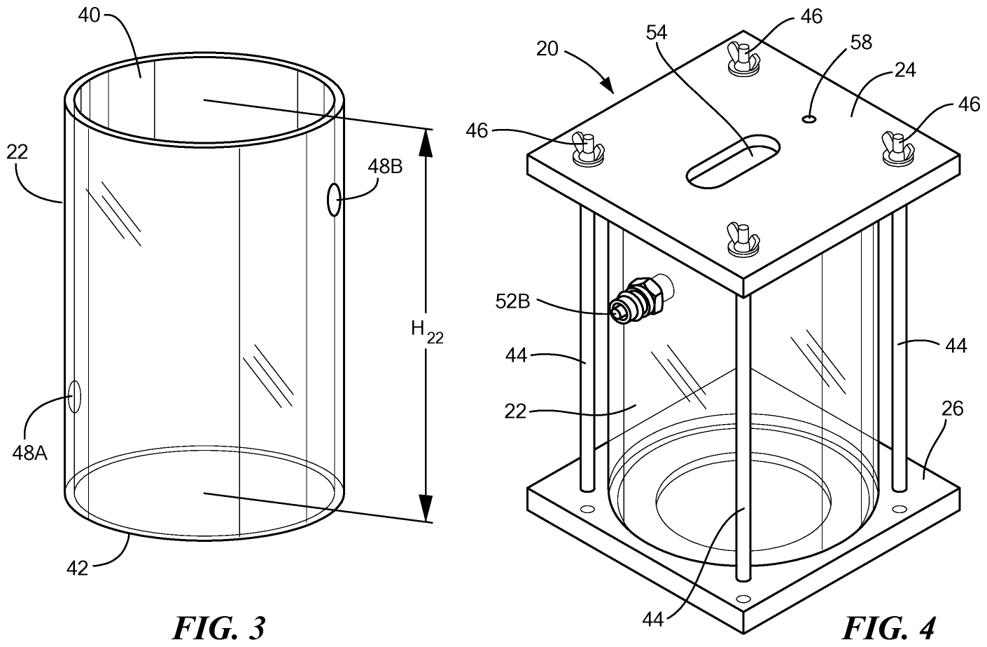

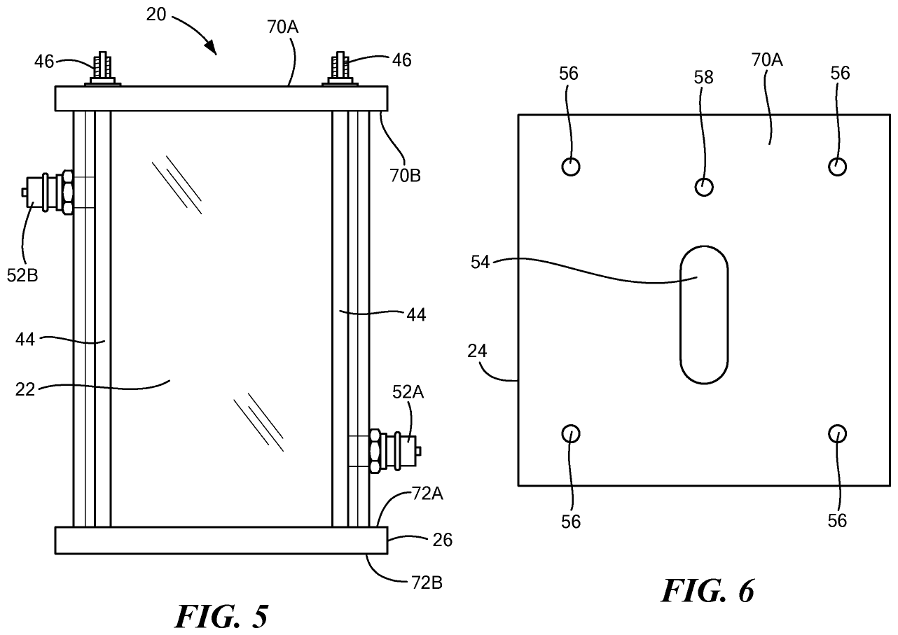

As shown in FIG. 5, the water bath tank 22 includes at least one aperture 48 and at least one water bath tube 28 for the circulation of heat exchange fluid 17 within the first closed-loop fluid flow path 12. In one embodiment, the water bath tank 22 includes a first aperture 48A and a second aperture 48B generally opposite the first aperture (that is, approximately 180° from the first aperture 48A). In one embodiment, the first aperture 48A is located closer to the bottom end plate 26 than the second aperture 48B. For example, warmer heat exchange fluid 17 may enter the water bath tank 22 through the first aperture 48A, which is at a lower height than the second aperture 48B, to enhance circulation and/or mixing of the heat exchange fluid 17 within the heat exchange assembly 16. In one embodiment, the first closed-loop fluid flow path 12 includes a single water bath tube 28 with a first end 50A that is coupled to the first aperture 48A and a second end 50B that coupled to the second aperture 48B. In another embodiment, the first closed-loop fluid flow path 12 includes two water bath tubes 28A, 28B, each extending between a corresponding one of the apertures 48A, 48B, and at least one other system component, such as a pump 30 and/or a temperature modification element 32. Heat exchange fluid with the water bath tube 28 may be in thermal exchange with a temperature modification element 32 that is configured to adjust and/or maintain the heat exchange fluid at body temperature (37° C./98.6° F.), or any target temperature. Further, the water bath tube 28 is in communication with a pump 30 to circulate heat exchange fluid within the water bath tube 28 and water bath tank 22. In another embodiment, the first closed-loop fluid flow path 12 includes a first water bath tube 28A coupled to the first aperture 48A and a second water bath tube 28B coupled to the second aperture 48B, and each of the first and second water bath tubes 28A, 28B are coupled to a heat exchange fluid source (not shown) and/or the temperature modification element 32. Further, the first and second water bath tubes 28A, 28B are in communication with a pump 30 to circulate heat exchange fluid within the first closed-loop fluid flow path 12. However, it will be understood that other configurations may also be used. Regardless of the configuration of the first closed-loop fluid flow path 12, one or more water bath tubes 28 are in fluid communication with the water bath tank 22 and the heat exchange fluid is circulated through the tube(s) 28 and water bath tank 22 while being adjusted to and/or maintained at body temperature. Additionally, in one embodiment, each water bath tube 28 is connected a corresponding aperture 48 in the water bath tank 22 with a connector element 52, such as a valve, a quick release connector, tube fitting, pipe connector, or the like (for example, as shown in FIGS. 3 and 4).

As shown in FIGS. 6-8, each of the top end plate 24 and the bottom end plate 26 includes a plurality of apertures. In one embodiment, the top end plate includes at least one sample aperture 54, at least one upright support aperture 56, and at least one auxiliary aperture 58. Each aperture may have any suitable size, shape, or configuration. In one non-limiting example, the top end plate 24 includes a sample aperture 54 having an elongate shape (for example, an oval, rectangle, rounded rectangle, or the like), four upright support apertures 56, and at least one auxiliary aperture 58 (as shown in FIGS. 6-8). The upright support apertures 56 and auxiliary aperture(s) 58 may each be, for example, round and have a size that is smaller than the size of the sample aperture 54. In one embodiment, the top end plate 24 and the bottom end plate 26 each has a square shape, the upright support apertures 56 of each of the top and bottom end plates 24, 26 are arranged in an approximately square configuration, and an auxiliary aperture 58 of each of the top and bottom end plates 24, 26 is aligned with a longitudinal axis of the elongate sample aperture 54. In one non-limiting example, each side of the top and bottom end plates is approximately 9.00 inches (±0.5 inch) in length, and the sample aperture 54 is approximately 3.25 inches (±0.5 inch) and has a center point 60 that is offset from the center point 61 of the top end plate.

In one embodiment, the bottom end plate 26 includes at least one gasket membrane aperture 62 and at least one upright support aperture 56. The apertures may have any suitable size, shape, or configuration. In one non-limiting example, the bottom end plate 26 includes four upright support apertures 56 having the same size, configuration and arrangement as the four upright support apertures 56 in the top end plate 24. Further, each of the upright support apertures 56 of the bottom end plate 26 is located directly beneath, or in vertical alignment with, a corresponding one of the upright support apertures 56 of the top end plate 24 when the housing assembly 20 is assembled and the blood loop 10 is in use. In one embodiment, the gasket membrane aperture 62 is a round aperture located in the center of the bottom end plate 26 (that is, at a location that is equidistant from the vertices of the bottom end plate 26). In one non-limiting example, the diameter D62 of the gasket membrane aperture 62 is approximately 5.00 inches (±0.05 inch). However, it will be understood that the gasket membrane aperture 62 may have any suitable size, shape, or configuration to provide a suitable functionality of the gasket membrane 64, as discussed below.

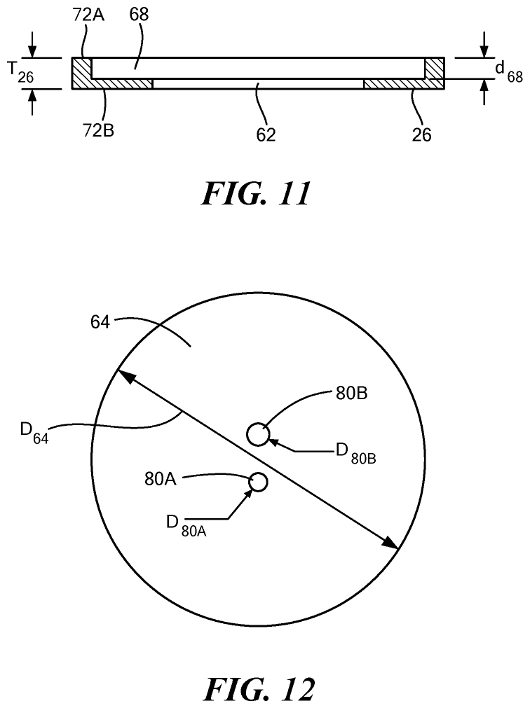

As shown in the cross-sectional views in FIGS. 8 and 11, each of the top and bottom end plates 24, 26 may include a recessed area 66, 68 that is sized to receive a portion of the water bath tank 22, thereby facilitating seating of the top and bottom end plates 24, 26 on the water bath tank 22 and reducing the possibility of fluid leaks. In one embodiment, shown in FIG. 8, the top end plate 24 includes an upper or first surface 70A and a lower or second surface 70B. The sample aperture 54 extends all the way between the upper and lower surfaces 70A, 70B. As one non-limiting example, the sample aperture 54 is sized and configured to allow a sample bag, such as the blood sample bag 34 shown in FIG. 2, to be passed therethrough (although the blood sample bag 34 may be folded or compressed to fit through the sample aperture 54). The lower surface 70B includes a circular recessed area 66 that is sized to receive a portion of the first end 40 of the water bath tank 22. In one embodiment, the circular recessed area 66 has a diameter D66 that is only slightly larger than the outer diameter of the water bath tank 22. In one non-limiting example, the outer diameter OD22 of the water bath tank 22 may be 8.00 inches and the diameter of the circular recessed area 66 may be approximately 8.00 inches±0.065 inch, the thickness T24 of the top end plate 24 may be approximately 0.625 inch and the depth d66 of the circular recessed area 66 may be approximately 0.25 inch. Further, in one embodiment, the diameter of the circular recessed area 66 may be sized such that the top end plate 24 can be friction fit to the first end 40 of the water bath tank 22. Alternatively, in another embodiment, the circumference of the circular recessed area 66 may be large enough to prevent a friction fit between the top end plate 24 and the first end 40 of the water bath tank 22. In one embodiment, the housing assembly 20 includes an o-ring or gasket to create a fluid-tight seal between the top end plate 24 and the water bath tank 22. For example, the housing assembly may include an o-ring between the first end 40 of the water bath tank 22 and the circular recessed area 66 of the top end plate 24.

In one embodiment, shown in FIG. 11, the bottom end plate 26 includes an upper or first surface 72A and a lower or second surface 72B. The gasket membrane aperture 62 extends all the way between the upper and lower surfaces 72A, 72B. The upper surface 72A includes a circular recessed area 68 that is sized to receive a portion of the second end 42 of the water bath tank 22. In one embodiment, the circular recessed area 68 has a diameter that is only slightly larger than the outer diameter of the water bath tank 22. In one non-limiting example, the outer diameter of the water bath tank 22 may be 8.00 inches and the diameter D68 of the circular recessed area 68 may be approximately 8.00 inches±0.065 inch, the thickness T26 of the bottom end plate 26 may be approximately 0.75 inch and the depth d68 of the circular recessed area 68 may be approximately 0.5 inch. Further, in one embodiment, the diameter of the circular recessed area 68 may be sized such that the bottom end plate 26 can be friction fit to the second end 42 of the water bath tank 22. Alternatively, in another embodiment, the circumference of the circular recessed area 68 may be large enough to prevent a friction fit between the bottom end plate 26 and the second end 42 of the water bath tank 22. In one embodiment, the housing assembly 20 includes an o-ring or gasket to create a fluid-tight seal between the bottom end plate 26 and the water bath tank 22. For example, the housing assembly 20 may include an o-ring between the second end 42 of the water bath tank 22 and the circular recessed area 68 of the bottom end plate 26.

The second closed-loop fluid flow path 14 generally includes a blood sample bag 34, at least one sample tube 36 in fluid communication with the blood sample bag 34, and a pump 38 (such as a roller pump) for circulating the blood throughout the second closed-loop fluid flow path 14. The blood sample to be tested may be contained within a blood sample bag 34, which is placed within the heat exchange assembly 16 (for example, the water bath tank 22), where it is maintained at body temperature (37° C./98.6° F.). The blood sample bag 34 may have any suitable size, shape, and configuration that allows it to be contained within the water bath tank 22 and, optionally, to be inserted into the water bath tank 22 through the sample aperture 54 in the top end plate 24. In one embodiment, the blood sample bag 34 is composed of a flexible, clear material and includes a first port 74A and a second port 74B at the bottom of the blood sample bag 34 (that is, the edge or side of the blood sample bag 34 that is located closest to the bottom end plate 26 when the blood loop 10 is in use). The first and second ports 74A, 74B are configured to be in fluid communication with a first end 76A and a second end B of the sample tube 36, and each of the first and second ports 74A, 74B may include a valve 78, clamp 79, and/or other component for metering a flow of blood between the blood sample bag 34 and the sample tube 36 and/or for establishing a secure, fluid-tight connection between the blood sample bag 34 and the sample tube 36.

Referring now to FIG. 12, a gasket membrane 64 is shown. In one embodiment, the gasket membrane 64 is a flexible sheet of material that is sized and configured to be seated within the circular recessed area 68 of the bottom end plate 26. The gasket membrane 64 is composed of a flexible, resilient material such as rubber, silicone, or the like. Further, in one embodiment, the gasket membrane 64 includes a first aperture 80A and a second aperture 80B. The first 80A and second 80B apertures may be circular (as shown in FIG. 12) or may have any suitable size, shape, or configuration to allow the end portions of the sample tube 36 to pass therethrough (for example, as shown in FIG. 2). Further, in one non-limiting embodiment, as shown in FIG. 12, the first aperture 80A has a smaller diameter than the second aperture 80B. For example, the diameter D80B of the second aperture 80B may be approximately 0.10 inch (±0.05 inch) larger than the diameter D80A of the first aperture 80A (e.g., the first aperture 80A may have a circumference of approximately 0.44 inch and the second aperture 80B may have a circumference of approximately 0.53 inch). However, it will be understood that the first and second apertures 80A, 80B may have the same or different diameters, depending on the sizing of the sample tube(s) used in the blood loop 10 for a particular purpose. The gasket membrane 64 may have a diameter D64 of approximately 7.96 inches (±0.01 inch) and a thickness of approximately 0.06 inch (±0.02 inch). However, it will be understood that the gasket membrane 64 may have any suitable size, shape, and configuration.

The gasket membrane 64 forms a fluid-tight seal around the first and second end portions 82A, 82B of the sample tube 36 and prevents fluid from leaking from the water bath tank 22. In one embodiment, the gasket membrane 64 is positioned within the circular recessed area 68 of the bottom end plate 26 and is held in place by compressive force between the bottom end plate 26 and the second end 42 of the water bath tank 22. Additionally or alternatively, the gasket membrane 64 is physically and/or mechanically coupled to the bottom end plate 26, such as by chemical adhesives, chemical welding, or the like.

In one embodiment, the first closed-loop fluid flow path 12 and/or the second closed-loop fluid flow path 14 also include one or more sensors, including but not limited to flow sensors 84 and temperature sensors 86, as well a one or more sampling ports 88 through which the blood sample may be drawn for testing and analysis. In one non-limiting example, the sample tube 36 includes at least one flow sensor 84, at least one temperature sensor 86, and at least one sampling port 88. For example, the temperature sensor 86 may be an elongate rod that is extended through the auxiliary aperture 58 in the top end plate 24 and at least partially submersed within the heat exchange fluid 17 (as shown in FIG. 2). The at least one sampling port 88 is at a location in the sample tube 36 that is external to the water bath tank 22, such that the at least one sampling port 88 and the blood sample(s) drawn therethrough are not exposed to or in contact with the heat exchange fluid. This helps ensure that the blood sample(s) removed from the blood loop 10 are drawn cleanly and not cross-contaminated.

In one embodiment, the blood loop 10 also includes one or more communication units. For example, the one or more sensors 84, 86 and/or other components of the blood loop 10 may include a wireless communication unit, such as BLUETOOTH, infrared, Zigbee, near field communication (NFC), WiFi, etc. However, it is understood that implementations are not limited to only these technologies and that any wireless communication technology suitable for short-range communications can be used. In one embodiment, the wireless communication unit is in communication with the one or more sensors 84, 86 and a control unit 92, and is configured to transmit data recorded by the one or more sensors 84, 86 to the control unit 92 for user information and/or input. In one embodiment, the control unit 92 is also in communication with the temperature modification element 32 (for example, by wireless communication) and includes a display 94 used to communicate one or more system characteristics to the user. For example, the one or more sensors, such as temperature sensors 86, may transmit temperature data to the control unit 92. The control unit 92 then displays a temperature of the blood within the second closed-loop fluid flow path 14 to the user, based on the data received from the temperature sensor(s) 86. If the blood has not reached body temperature, the user may increase the target temperature of the first closed-loop fluid flow path 12 (for example, by directly adjusting the operating parameters of the temperature modification element 32, or by indirectly adjusting the operating parameters of the temperature modification element 32 through the control unit 92) in order to adequately increase the temperature of the blood within the second closed-loop fluid flow path 14. Likewise, one or more sensors, such as flow sensors 84, may transmit data to the control unit 92, which displays this data to the user. The user may then adjust a flow rate of either the first closed-loop fluid flow path 12 or the second closed-loop fluid flow path 14 manually or semi-automatically using the control unit 92. Additionally or alternatively, the control unit 92 may include processing circuitry 96 configured to automatically adjust one or more operating parameters of the blood loop 10. The processing circuitry 96 includes a processor and a memory. The memory is in electrical communication with the processor and has instructions that, when executed by the processor, configure the processor to, for example, receive electrical signals from the one or more sensors 84, 86, to process those signals into information usable and/or understandable by the user, and to communicate that information to the user.

In an exemplary method of assembly of the blood loop 10, the first connector element 52A is coupled to the first aperture 48A of the water bath tank 22 and the second connector element 52B is coupled to the second aperture 48B of the water bath tank 22. In one embodiment, the blood loop 10 includes a first water bath tube 28A, a second water bath tube 28B, a pump 30, and a temperature modification element 32. In this embodiment, the first water bath tube 28A is connected between the first connector element 52A and the pump 30 or the temperature modification element 32, and the second water bath tube 28B is connected between the second connector element 52B and the pump 30 or the temperature modification element 32.

The bottom end plate 26 is then coupled to the second end 42 of the water bath tank 22. For example, the water bath tank 22 is seated on the bottom end plate 26 such that a portion of the second end 42 of the water bath tank 22 is received within the circular recessed area 68 of the upper surface 72A of the bottom end plate 26 and the gasket membrane 64 (for example, an outer edge of the gasket membrane 64) is compressed between the second end 42 of the water bath tank 22 and the circular recessed area 68 of the upper surface 72A of the bottom end plate 26. In one embodiment, an outer edge of the gasket membrane 64 is adhered or mounted to the bottom end plate 26. Alternatively, the gasket membrane 64 may be merely placed within the circular recessed area 68 and held against the bottom end plate 26 by the water bath tank 22 and the pressure exerted between the top and bottom end plates 24, 26 and the water bath tank 22 by the upright supports 44 and tightening means 46 when the top end plate 24 is in place. The upright supports 44 are then extended through the upright support apertures 56 of the bottom end plate 26.

In one embodiment, the first end 76A and the second end 76B of the sample tube 36 are then passed through the first and second apertures 80A, 80B in the gasket membrane 64, respectively. Further, in one embodiment, the first and second ends 76A, 76B of the sample tube 36 are then placed into fluid communication with the first and second ports 74A, 74B of the blood sample bag 34, respectively, and the blood sample bag 34 is placed within the water bath tank 22. The top end plate 24 is then seated on the first end 40 of the water bath tank 22, with the upright supports 44 extending through the upright support apertures 56 in the top end plate 24, and the top end plate 24 and the bottom end plate 26 are then secured over the first and second ends 40, 42 of the water bath tank 22, respectively, by tightening the tightening means 46 (such as by rotating wingnuts on the upright supports 44 toward the top end plate 24). Alternatively, the top end plate 24 may be seated on the first end 40 of the water bath tank 22 and the blood sample bag 34 then inserted into the water bath tank 22 through the sample aperture 54. It will be understood that the blood loop 10 may be assembled in any order.

The one or more water bath tubes 28 are then coupled to the connector elements 52A, 52B and arranged in mechanical and/or fluid communication with the pump 30 and the temperature modification element 32. Heat exchange fluid is then added to the water bath tank 22 and allowed to circulate within the first closed-loop fluid flow path 12. In one embodiment, the temperature modification element 32 adjusts and/or maintains the temperature of the heat exchange fluid at or approximately at body temperature (37° C./98.6° F.). Put another way, in one embodiment, the heat exchange fluid is maintained at a target temperature, the target temperature being sufficient to adjust and/or maintain the temperature of the second closed-loop fluid flow path 14 at body temperature (37° C./98.6° F.).

The housing assembly 20 may then be placed on a surface (such as the horizontal surface 39 shown in FIG. 2) at a location that is above the ground or other work surface, such that the sample tube 36 is suspended from (that is, hangs vertically downward from) the housing assembly 20. The sample tube 36 is also placed into mechanical communication with a pump 38 that maintains circulation of the blood through the second closed-loop fluid flow path 14. In one embodiment, the pump 38 is a roller pump that circulates the blood through the second closed-loop fluid flow path 14 by physically manipulating the sample tube 36 but without coming into contact with the blood or otherwise being in fluid communication with the sample tube 36.

Once the blood loop 10 is assembled, heat exchange fluid is circulated through the first closed-loop fluid flow path 12 and blood is circulated through the second closed-loop fluid flow path 14. Further, the temperature of the blood within the second closed-loop fluid flow path 14 is adjusted and/or maintained by the heat exchange fluid within the first closed-loop fluid flow path 12 without submersing the sample tube 36 within the heat exchange fluid and while conserving laboratory space by virtue of the vertical arrangement of the blood loop 10. Blood sample(s) may be drawn through sampling port(s) 88 in the sample tube 36 for testing and/or analysis while the blood loop 10 is in use. Further, the blood loop 10 may be in wired and/or wireless communication with a control unit 92 with which the user may engage to manually or semi-automatically adjust and/or monitor the blood loop 10 and/or that is configured to automatically adjust and/or monitor the blood loop 10.

The temperature of the blood within the second closed-loop fluid flow path 14 is determined by the temperature of the heat exchange fluid within the first closed-loop fluid flow path 12. For example, the temperature of the blood within the blood sample bag 34 is heated, adjusted, and/or maintained at body temperature by the heat exchange fluid within the water bath tank 22, in which the blood sample bag 34 is submerged. As heat exchange fluid flows through the first closed-loop fluid flow path, the heat exchange fluid is re-warmed by the temperature modification element 32 and returned to the water bath tank 22 at a temperature that is sufficient to, for example, maintain the temperature of the blood within the blood sample bag 34 at body temperature. Likewise, the temperature of the blood may decrease as it flows away from the water bath tank 22 and through the second closed-loop fluid flow path 14, but is rewarmed to body temperature once it returns to the blood sample bag 34 within the water bath tank 22. Thus, the first closed-loop fluid flow path 12 and the second closed-loop fluid flow path 14 are fluidly isolated but in a thermal exchange relationship with each other.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A heat exchange assembly for a flow circuit, the heat exchange assembly comprising:
a housing assembly including:
a fluid reservoir including a first end and a second end opposite the first end;
at least one tube in fluid communication with the fluid reservoir, the fluid reservoir and the at least one tube being a closed-loop fluid flow path;
a first end plate coupled to the first end of the fluid reservoir; and
a second end plate coupled to the second end of the fluid reservoir.

2. The heat exchange assembly of claim 1, further comprising a pump, the pump being in at least one of mechanical and fluid communication with the at least one tube.

3. The heat exchange assembly of claim 2, wherein the pump is a roller pump.

4. The heat exchange assembly of claim 1, further comprising a temperature modification element, the heating element being in a thermal exchange relationship with the at least one tube.

5. The heat exchange assembly of claim 4, wherein the temperature modification element is a heating element.

6. The heat exchange assembly of claim 1, wherein the second end plate is vertically aligned with the first end plate.

7. The heat exchange assembly of claim 1, wherein the second end plate is horizontally aligned with the first end plate.

8. The heat exchange assembly of claim 4, wherein the closed-loop fluid flow path contains a heat exchange fluid.

9. The heat exchange assembly of claim 8, wherein the temperature modification element is configured to maintain a temperature of the heat exchange fluid at 37° C./98.6° F.

10. The heat exchange assembly of claim 1, wherein the housing assembly further includes a plurality of upright supports, each of the first end plate and the second end plate having a plurality of upright support apertures, the first end plate and the second end plate being coupled to the fluid reservoir by the plurality of upright supports.

11. The heat exchange assembly of claim 10, wherein each of the plurality of upright supports extends between a one of the plurality of upright support apertures in the second end plate and a corresponding one of the plurality of upright support apertures in the first end plate.

12. The heat exchange assembly of claim 1, wherein the second end plate includes a first surface, a second surface, a recessed area in the first surface, and a gasket membrane aperture extending between the first surface and the second surface.

13. The heat exchange assembly of claim 12, further comprising a gasket membrane seated within the recessed area in the second end plate, the gasket membrane including a first aperture and a second aperture.

14. A blood loop comprising:
a first closed-loop fluid flow path, the first closed-loop fluid flow path including:
a housing assembly having:
a fluid reservoir with a first end and a second end opposite the first end, the fluid reservoir containing a heat exchange fluid;
a top end plate coupled to the first end of the fluid reservoir;
a bottom end plate coupled to the second end of the fluid reservoir, the bottom end plate having an aperture; and
a gasket membrane extending across the aperture in the bottom end plate;
at least one heat exchange fluid tube in fluid communication with the fluid reservoir;
a first pump in at least one of fluid communication and mechanical communication with the at least one heat exchange fluid tube, the first pump being operable to circulate the heat exchange fluid within the first closed-loop fluid flow path; and
a temperature modification element, the temperature modification element being in a thermal exchange relationship with the at least one heat exchange fluid tube; and
a second closed-loop fluid flow path, the second closed-loop fluid flow path including:
a sample bag located within the fluid reservoir, the sample bag containing a sample fluid;
at least one sample tube in fluid communication with the sample bag, at least a portion of the at least one sample tube extending through the gasket membrane such that the at least one sample tube is suspended from the housing assembly; and
a second pump in mechanical communication with the at least one sample tube, the second pump being operable to circulate the sample fluid throughout the second closed-loop fluid flow path.

15. The blood loop of claim 14, wherein a temperature of the sample fluid is maintained at body temperature by a temperature of the heat exchange fluid.

16. The blood loop of claim 14, wherein the first closed-loop fluid flow path is in a thermal exchange relationship with the second closed-loop fluid flow path.

17. The blood loop of claim 14, wherein the top end plate and the bottom end plate are vertically aligned, the at least one sample tube being vertically suspended from the bottom end plate.

18. The blood loop of claim 14, wherein the at least one sample tube includes a sampling port, the sampling port being located external to the fluid reservoir.

19. An in vitro closed-loop blood circulation system comprising:
a first closed-loop fluid flow path containing a warming fluid circulated therein and including a vertically oriented housing assembly; and
a second closed-loop fluid flow path containing a sample fluid circulated therein, the first closed-loop fluid flow path and the second closed-loop fluid flow path being in a thermal exchange relationship with each other, at least a portion of the second closed-loop fluid flow path being vertically suspended from the vertically oriented housing assembly.

20. The system of claim 19, wherein the second closed-loop fluid flow path includes at least one sensor, the system further comprising:
a control unit in communication with the at least one sensor.

21. The system of claim 20, wherein the control unit is configured to automatically adjust the system such that a temperature of the sample fluid is maintained at body temperature.

22. The system of claim 19, wherein the first closed-loop fluid flow path further includes a temperature modification element, the temperature modification element being configured to maintain a temperature of the warming fluid at body temperature.
